(19) United States
(12) Patent Application Publication
(10) Pub. No.: US 2009/0270003 A1
(43) Pub. Date: Oct. 29, 2009

(54) MICROSPHERE PRESSURE SENSITIVE ADHESIVE COMPOSITION

(75) Inventors: Kelly S. ANDERSON, Houlton, WI (US); Ying-Yuh Lu, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/428,090

(22) Filed: Apr. 22, 2009

Related U.S. Application Data
(60) Provisional application No. 61/047,208, filed on Apr. 23, 2008.

(51) Int. Cl. B32B 7/12; C08L 33/04; C08L 39/04; C08L 33/26

(52) U.S. Cl. 442/151; 524/832; 524/556; 524/808; 524/831; 524/548; 524/555; 428/355 AC; 428/344; 428/352

(57) ABSTRACT

The present disclosure provides an adhesive made from a reaction product of (a) polymerizable acrylate derived from one or more alcohols selected from the group consisting of C₄ alcohols, C₅ alcohols, and combinations thereof wherein at least one of the alcohols is derived from a non-petroleum resource; (b) initiator; (c) stabilizer, wherein the reaction occurs in water to yield a microsphere adhesive. The microsphere adhesive can be formulated into a pressure sensitive adhesive composition that can be applied to various substrates such as paper and polymeric film to produce repositionable adhesive coated articles such as tapes, notes, flags, easels and the like.

### PRIORITY CLAIM

This application claims priority to U.S. Provisional Application No. 61/047,208, filed Apr. 23, 2008.

### FIELD OF INVENTION

This invention relates to pressure-sensitive adhesive compositions, in particular, to pressure sensitive adhesive compositions comprising one or more polymerized monomer(s) derived at least in part from non-petroleum sources.

### BACKGROUND

Certain pressure sensitive adhesives (“PSAs”) are known to possess the following properties: (1) aggressive and permanent tack, (2) adherence with no more than finger pressure, (3) sufficient ability to hold onto a substrate, and (4) sufficient cohesive strength to be removed cleanly from the substrate. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.).

Microsphere adhesives have proven to be extremely useful for use in PSAs because they allow a PSA-bearing article to be repositionable, i.e., to be attached and re-attached to different surfaces multiple times. Thus, microsphere adhesives have been used in consumable products such as, but not limited to, repositionable notes, repositionable flags or index, and repositionable easel pads. Important characteristics of microsphere PSAs include, e.g., cost, manufacturability, environmental impact, toxicity, and, of course, the above-noted adhesive properties. Typically, such adhesives comprise a reaction product of (a) a polymerizable monomer derived from petroleum-based resources, e.g., C₄ to C₁₄ alkyl(meth)acrylate, optionally a comonomer; (b) an initiator; and (c) a stabilizer, wherein the reaction occurs in water to yield a microsphere adhesive. Illustrative examples of such adhesives are disclosed in U.S. Pat. No. 5,571,617 (Cooprider et al.) and U.S. Pat. No. 5,714,237 (Cooprider et al.). Typically such monomers have been derived from petroleum-based sources.

The need exists for new adhesive compositions, and other products, that are made from renewable raw materials.

### SUMMARY

It has now been found that highly desirable microsphere PSAs can be made by using monomers derived from non-petroleum resources. While microspheres used in PSAs for decades have relied on petroleum derived monomers, it has been found that microspheres made from non-petroleum derived monomers result in excellent PSAs. In particular, the non-petroleum derived microspheres and PSAs made therefrom are cost effective, manufacturable, environmentally friendly (enabling reduction in use of petroleum-based feedstocks and reduction in omission of greenhouse gases), and have low adhesion build to paper over an extended period of time or good vertical hang properties. Thus, some of the advantages provided by the adhesive compositions of the invention include reduction in use of petroleum derived materials, reduction in emission of global warming gases, and superior or improved adhesive performance.

The present disclosure provides a solution for making microsphere adhesives derived from a reaction product of, among other components, at least one polymerizable monomer, where at least a portion of the monomer is derived from a non-petroleum resource. Nonlimiting examples of non-petroleum resource for the polymerizable monomers include alcohols obtained from fusel oil. The microsphere adhesives can be mixed with other constituents to form a microsphere PSA composition that can then be applied to various substrates or backing to yield articles such as tapes, labels, adhesive coated notes and flags, and the like. Advantageously, the article containing the microsphere PSA composition disclosed herein is repositionable.

In one aspect, the present disclosure provides an adhesive composition made from a reaction product comprising or in some embodiments consisting essentially of:
(a) a polymerizable monomer derived at least in part from one or more alcohols selected from the group consisting of C₄ alcohols, C₅ alcohols, and combinations thereof wherein at least one of the alcohols is derived from a non-petroleum resource,
(b) an initiator, and
(c) a stabilizer,
   wherein the reaction occurs in water and the adhesive is a microsphere adhesive. The stabilizer may include a polymeric stabilizer, a surfactant, and a combination thereof.

In another aspect, the present disclosure pertains to an adhesive composition comprising, or in some embodiments consisting essentially of, a reaction product of:
(a) from about 92 to 99.9 weight percent (wt %) of at least one polymerizable acrylate derived from esterification of (i) one or more alcohols selected from the group consisting of C₄ alcohols, C₅ alcohols, and combinations thereof and (ii) (meth)acrylic acid, wherein at least one of said alcohol and said (meth)acrylic acid is derived from a non-petroleum resource;
(b) from about 0.01 to 4 wt % of stabilizer; and
(c) from about 0.01 to 4.0 wt % of initiator
   wherein the wt % of each component is based on the total weight of components (a) to (c) and wherein the reaction occurs in water to yield a microsphere adhesive. The stabilizer may include a polymeric stabilizer, a surfactant, and a combination thereof.

In yet another aspect, the present disclosure pertains to an adhesive composition comprising, or in some embodiments consisting essentially of, a reaction product of:
(a) from about 87 to 99.9 wt % of at least one polymerizable acrylate derived from esterification of (i) one or more alcohols selected from the group consisting of C₄ alcohols, C₅ alcohols, and combinations thereof and (ii) (meth)acrylic acid, wherein at least one of said alcohol and said (meth)acrylic acid is derived from a non-petroleum resource;
(b) from about 0.01 to 5 wt % of at least one surfactant(s);
(c) from about 0.01 to 4 wt % of at least one polymeric stabilizer(s);
(d) from about 0.01 to 4 wt % of at least one initiator(s);
   wherein the wt % of each component is based on the total of components (a) to (d);
(e) up to about 75 wt %, based on component (a), of at least one alkyl(meth)acrylate comonomer(s) having from about 1 to 14 carbon atoms;
(f) less than about 5 wt %, based on component (a), of at least one polar comonomer(s);
(g) up to about 10 wt %, based on component (a), of at least one amido comonomer(s);
(h) up to about 10 wt %, based on component (a), of at least one polyethylene oxide(meth)acrylate(s);
(i) up to about 0.2 wt %, based on component (a), of at least one chain transfer agent(s);
(j) up to about 1 wt %, based on component (a), of at least one crosslinker(s);
(k) up to about 30 wt %, based on component (a), of at least one solute polymer(s);
(l) up to about 5 wt %, based on component (a), of at least one amino comonomer(s);
(m) up to about 5 wt %, based on component (a), of at least one ionic monomer(s); and
(n) up to about 20 wt %, based on component (a), of at least one vinyl or vinylester comonomer,
   wherein the reaction occurs in water to yield a microsphere adhesive.

### DETAILED DESCRIPTION OF ILLUSTRATIVE EMBODIMENTS

All numbers are herein assumed to be modified by the term “about” where appropriate. The recitation of numerical ranges by endpoints includes all numbers subsumed within that range (e.g., 1 to 5 includes 1, 1.5, 2, 2.75, 3, 3.80, 4, and 5).

As used herein, the term “non-petroleum” refers generally to a compound for which crude oil or its derivatives are not the ultimate raw material (i.e., starting material). An exemplary non-petroleum resource includes, but is not limited to, bio-based resources, such as those derived from plants. As used herein, an article is “repositionable” if it can be attached to and removed from display surfaces multiple times without damaging and leaving adhesive residue upon the intended display surface. As used herein the term “(meth)acrylate” includes acrylate and methacrylate.

To determine if a polymerizable monomer contains bio-based content so that it is considered non-petroleum based, one can use ASTM D 6866-06a, Standard Test Methods for Determining the Biobased Content of Natural Range Materials Using Radiocarbon and Isotope Ratio Mass Spectrometry Analysis. As described herein, adhesive compositions of the present invention can be made which have biobased carbon content of at least about 30%, preferably at least about 40%, and most preferably at least about 50%, and in some embodiments, of at least about 60% as determined in accordance with this ASTM. The “biobased carbon content” refers to the proportion of total carbon in the composition that originates through use of biologically produced feedstocks, e.g., monomer materials derived from fermentation of plant matter or extracted from plants directly, as opposed to being derived from petroleum sourced materials such as the alkyl(meth)acrylates that are derived from petroleum sources.

Polymerizable Monomer(s)

Now turning to the various components used in the reaction mixture of the microsphere adhesive, exemplary polymerizable monomers can be derived from fusel oil, e.g., by esterification of the alcohols in fusel oil with (meth)acrylic acid to form corresponding (meth)acrylates.

Fusel oil, sometimes referred to as fusel alcohol, is a non-petroleum material or resource available as a by-product stream from ethanol distillation. The fusel oil can come from many different sugar sources, illustrative examples including corn, sugar cane, grass, etc. Fusel oils typically contain mixtures of C₄ and C₅ alcohols such as butanol and amyl alcohol with quntatities of smaller, e.g., C₂ and C₃ alcohols. An illustrative commercially available fusel oil has the following manufacturer's specification: up to 10 wt % ethanol, 10 to 17 wt % water, 40 to 70 wt % C₅ alcohols, 7 to 14 wt % isobutanol, 2 to 7 wt % 1-propanol, and up to 3 wt % other alcohols (e.g., butanol, methanol, etc.). One illustrative commercial fusel oil contains 3.8 wt % of 1-propanol, 6.9 wt % of isobutanol, 1.0 wt % of 1-butanol, 11.2 wt % of 2-methyl-1-butanol, and 77.2 wt % of 3-methyl-1-butanol (normalized to alcohol components). If desired, purified fusel oil containing primarily the C₅ alcohols, mainly 3-methyl-1-butanol and some 2-methyl-1-butanol, can be used in the present invention.

The (meth)acrylic acid is a monomeric compound that can be derived from petroleum-based resources or, as is typically preferred, can also be derived from non-petroleum resources via a number of suitable routes. Examples of such routes are provided below.

Glycerol derived from a non-petroleum based material (e.g., via hydrolysis of soybean oil and other triglyceride oils) may be converted into (meth)acrylic acid according to a two-step process. In a first step, the glycerol is dehydrated to yield acrolein. A suitable conversion process involves exposing gaseous glycerol to an acidic solid catalyst, such as H₃PO₄ on an aluminum oxide carrier to yield acrolein. Specifics relating to dehydration of glycerol to yield acrolein are disclosed, for instance, in U.S. Pat. Nos. 2,042,224 and 5,387,720. In a second step, the acrolein is oxidized to form acrylic acid. A particularly suitable process involves a gas phase interaction of acrolein and oxygen in the presence of a metal oxide catalyst, such as molybdenum and vanadium oxide catalysts. Specifics relating to oxidation of acrolein to yield (meth)acrylic acid are disclosed, e.g., in U.S. Pat. No. 4,092,354.

Glucose derived from a non-petroleum based material (e.g., via enzymatic hydrolysis of corn starch) may be converted into (meth)acrylic acid via a two step process with lactic acid as an intermediate product. In the first step, glucose is bio-fermented to yield lactic acid. Any suitable microorganism capable of fermenting glucose to yield lactic acid may be used including members from the genus Lactobacillus such as Lactobacillus lactis as well as those identified in U.S. Pat. Nos. 5,464,760 and 5,252,473. In the second step, the lactic acid is dehydrated to produce (meth)acrylic acid by use of an acidic dehydration catalyst such as an inert metal oxide carrier that has been impregnated with a phosphate salt. This acidic dehydration catalyzed method is described in further detail in U.S. Pat. No. 4,729,978. In an alternate suitable second step, the lactic acid is converted to (meth)acrylic acid by reaction with a catalyst comprising solid aluminum phosphate, as described in further detail in U.S. Pat. No. 4,786,756.

Another suitable reaction pathway for converting glucose into (meth)acrylic acid involves a two step process with 3-hydroxypropionic acid as an intermediate compound. In the first step, glucose is bio-fermented to yield 3-hydroxypropionic acid. Microorganisms capable of fermenting glucose to yield 3-hydroxypropionic acid have been genetically engineered to express the requisite enzymes for the conversion. For example, a recombinant microorganism expressing the dhaB gene from Klebsiella pneumoniae and the gene for an aldehyde dehydrogenase has been shown to be capable of converting glucose to 3-hydroxypropionic acid. Specifics regarding the production of the recombinant organism may be found in U.S. Pat. No. 6,852,517. In the second step, the 3-hydroxypropionic acid is dehydrated to produce (meth)acrylic acid.

Glucose derived from a non-petroleum based material (e.g., via enzymatic hydrolysis of corn starch obtained from the bio-based resource of corn) may be converted into (meth)acrylic acid by a multistep reaction pathway. Glucose is fermented to yield ethanol. Ethanol may be dehydrated to yield ethylene. At this point, ethylene can be polymerized to form polyethylene. However, ethylene can also be converted into propionaldehyde by hydroformylation of ethylene using carbon monoxide and hydrogen in the presence of a catalyst such as cobalt octacarbonyl or a rhodium complex. Propan-1-ol can be formed by catalytic hydrogenation of propionaldehyde in the presence of a catalyst such as sodium borohydride and lithium aluminum hydride. Propan-1-ol is dehydrated in an acid catalyzed reaction to yield propylene. At this point, propylene can be polymerized to form polypropylene. However, propylene can also be converted into acrolein by catalytic vapor phase oxidation. Acrolein may then be catalytically oxidized to form (meth)acrylic acid in the presence of a molybdenum-vanadium catalyst.

Polymeric Stabilizers

One or more polymeric stabilizers are used in the reaction mixture to prepare the microsphere adhesive. Advantageously, the presence of the stabilizer permits the use of relatively low amounts of surfactants while still obtaining microspheres.

Any polymeric stabilizer that effectively provides sufficient stabilization of the final polymerized droplets and prevents agglomeration within a suspension polymerization process is useful in this disclosure. When used, the polymeric stabilizer component(s) will typically be presented in the reaction mixture in an amount by weight of 0.01 to 4 parts by weight per 100 parts of polymerizable monomer(s), and more preferably will be present in an amount by weight of 0.04 to 2 parts by weight per 100 parts of polymerizable monomer(s).

Suitable polymeric stabilizers include, but are not limited to, salts of polyacrylic acids of greater than 5000 weight average molecular weight (e.g., ammonium, sodium, lithium and potassium salts), carboxy modified polyacrylamides (e.g., CYANAMER® A-370 from American Cyanamid), copolymers of acrylic acid and dimethylaminoethylmethacrylate and the like, polymeric quaternary amines (e.g., General Alanine and Film's GAFQUAT® 755, a quaternized polyvinyl-pyrollidone copolymer, or Union Carbide's “JR-400”, a quaternized amine substituted cellulosic), cellulosics, and carboxy-modified cellulosics (e.g., Hercules' NATROSOL® CMC Type 7L, sodium carboxy methycellulose), and polyacrylamide (e.g., CYANAMER™ N300 from Cytek).

Initiators

One or more initiators are used in the reaction mixture to prepare the microsphere adhesive. Initiators affecting polymerization are those that are normally suitable for free-radical polymerization of the polymerizable monomers. Suitable initiators include, but are not limited to, thermally-activated initiators such as azo compounds, hydroperoxides, peroxides and the like. Suitable photoinitiators include, but are not limited to, benzophenone, benzoin ethyl ether and 2,2-dimethoxy-2-phenyl acetophenone. Other suitable initiators include lauroyl peroxide and bis(t-butyl cyclohexyl)peroxy dicarbonate.

The initiator(s) is/are present in a catalytically effective amount sufficient to bring about high monomer conversion in a predetermined time span and temperature range. Typically, the initiator component(s) is/are present in amounts ranging from 0.01 to approximately 4 parts per weight per 100 parts by weight of the polymerizable monomer(s). Parameters that affect the concentration of initiator(s) used include the type of initiator(s) and particular monomer(s) involved. Depending upon the embodiment, catalytically effective total initiator concentrations will typically range from about 0.03 to about 2 parts by weight and more preferably, from about 0.05 to about 0.50 parts by weight per 100 parts of the polymerizable monomer(s).

Surfactants

One or more surfactant(s) may be used in the reaction mixture to prepare the microsphere adhesive, e.g., to facilitate achieving the desired particle size. As will be understood by those skilled in the art, the surfactant(s) will typically be present in the reaction mixture in a total amount of up to about 5 parts by weight per 100 parts by weight of polymerizable monomer content, sometimes up to about 3 parts by weight, and in some embodiments in the range of 0.2 to 2 parts by weight per 100 parts by weight of polymerizable monomer(s).

Useful surfactants include anionic, cationic, nonionic or amphoteric surfactants. Useful anionic surfactants include, but are not limited to, alkyl aryl sulfonates, e.g., sodium dodecylbenzene sulfonate and sodium decylbenzene sulfate, sodium and ammonium salts of alkyl sulfates, e.g., sodium lauryl sulfate, and ammonium lauryl sulfate. Useful nonionic surfactants include, but are not limited to, ethoxylated oleoyl alcohol and polyoxyethylene octylphenyl ether. Useful cationic surfactants include, but are not limited to, a mixture of alkyl dimethylbenzyl ammonium chlorides wherein the alkyl chain contains from 10 to 18 carbon atoms. Useful amphoteric surfactants include, but are not limited to, sulfobetaines, N-alkylaminopropionic acids, and N-alkybetaines.

Chain Transfer Agent

Depending upon the desired application, one or more modifier(s) may be used to regulate the solvent soluble portion (percent extractable) of the microspheres. As will be understood by those skilled in the art, if used, such agents are often added to the reaction mixture in an amount sufficient to provide a solvent soluble portion that is in the range of 10 to 98%, preferably in the range of 15 to 80%. Various modifiers may be used. The amounts used are those that sufficiently provide the microspheres with a solvent soluble portion.

Particularly useful modifiers are chain transfer agents. To control the molecular weight of the polymer being formed in the microsphere it is desirable to use a chain transfer agent. Many halogen-and sulfur-containing organic compounds function well as chain transfer agents in free radical polymerizations. Non-limiting examples of such agents are: carbon tetrabromide, carbon tetrachloride, dodecanethiol, iso-octylthioglycolate, butyl mercaptan, and tertiary-dodecyl mercaptan. The amount of chain transfer agent suitable for these microsphere polymerizations is calculated on a weight basis to the entire polymerizable monomer content. When used, chain transfer agents are typically added at amounts totaling up to about 0.2 wt %, in some embodiments totaling up to about 0.12 wt %, and in still other embodiments totaling up to about 0.08 wt % based on the total amount of the polymerizable monomer content. These levels are adequate to provide a soluble polymer content in the microsphere of up to about 98%.

Crosslinking Agent

One or more crosslinking agent(s) may be used in the reaction mixture to modify the properties of the resultant adhesive if desired as will be understood by those skilled in the art. Nonlimiting examples of suitable crosslinking agents include multifunctional (meth)acrylate and multifunctional vinyl. Suitable multifunctional crosslinkers include, but are not limited to, di(meth)acrylate, tri(meth)acrylate, tetra(meth)acrylate, divinylbenzene, and combinations thereof. Non-limiting examples of multifunctional crosslinkers include 1,6-hexanediol di(meth)acrylates, butanedioldi(meth)acrylates, poly(ethylene glycol)di(meth)acrylates, polybutadiene di(meth)acrylates, polyurethane di(meth)acrylates, propoxylated glycerin tri(meth)acrylates, divinylbenzene, and combinations thereof. When used, crosslinker(s) is (are) added at a level of up to about 1 wt %, preferably up to about 0.5 wt %, of the polymerizable monomer content used in the reaction mixture. The combination of crosslinking agent and modifier concentrations are chosen to obtain a microsphere with 10 to 98% solvent soluble portion.

Polymerizable Comonomers

The reaction mixture can further include one or more polymerizable comonomers including the following: alkyl(meth)acrylates where the alkyl group contains 1 to 14 carbon atoms, vinyl ester monomers, ionic monomers, polar monomers, amino-functional monomers, amido-functional monomers, and monomers having a nucleus or portion of the nucleus. Each type of polymerizable comonomers, whether derived from a petroleum or non-petroleum resource, is further described in detail below.

Depending upon the desired results, up to 20 wt %, in some embodiments up to 50 wt %, and in still other embodiments up to 75 wt % based on the fusel oil (meth)acrylate content, of alkyl(meth)acrylate can be used. Suitable alkyl(meth)acrylate include, but are not limited to isooctyl(meth)acrylate, 2-Octyl(meth)acrylate, isononyl(meth)acrylate, isoamyl(meth)acrylate, isodecyl(meth)acrylate, 2-ethylhexyl(meth)acrylate, n-butyl(meth)acrylate, sec-butyl(meth)acrylate, propyl(meth)acrylate, ethyl(meth)acrylate, methyl(meth)acrylate, isobornyl(meth)acrylate, 4-methyl-2-pentyl(meth)acrylate, 2-methylbutyl(meth)acrylate, t-butyl(meth)acrylate, and mixtures thereof.

When used in the reaction mixture to produce the microsphere adhesive, depending upon the desired properties, up to 5 wt %, preferably up to 2 wt % and more preferably, up to 0.5 wt %, based on the fusel oil (meth)acrylate content, of a polar comonomer can be used. The polar comonomer may or may not contain a dissociable hydrogen. Nonlimiting examples of polar comonomers include organic carboxylic acids having 3 to about 12 carbon atoms and having generally 1 to about 4 carboxylic acid moieties, and hydroxyl(alkyl)(meth)acrylates. Nonlimiting examples of such comonomers include itaconic acid, fumaric acid, crotonic acid, maleic acid, beta-carboxyethylacrylate, 2-hydroxyethyl(meth)acrylate, 4-hydroxybutyl(meth)acrylate, and glycercol mono(meth)acrylate. While (meth)acrylic acid can be used a polar comonomer, less than 0.5% is used in the reaction product. When more than 0.5% of the (meth)acrylic acid is used in the reaction mixture, coagulation problems may arise.

When used in the reaction mixture to produce the microsphere adhesive, up to 20 wt %, based on the fusel oil (meth)acrylate content, of a vinyl or vinyl ester comonomer can be used. Nonlimiting examples of vinyl ester comonomers include vinyl 2-ethylhexanoate, vinyl caprate, vinyl laurate, vinyl pelargonate, vinyl hexanoate, vinyl propionate, vinyl decanoate, vinyl actanoate, vinyl acetate and other monofunctional unsaturated vinyl esters of linear or branched carboxylic acids comprising 1 to 14 carbon atoms. Nonlimiting examples of vinyl comonomer include styrene and alpha-methylstyrene.

When used in the reaction mixture to produce the microsphere adhesive, depending upon the desired properties, up to 1 wt %, in some embodiments up to 2 wt %, and in some other embodiments up to 5 wt %, based on the fusel oil (meth)acrylate content, of an ionic comonomer can be used. Nonlimiting examples of ionic comonomers include sodium styrene sulfonate, sodium(meth)acrylate, ammonium(meth)acrylate, trimethylamine p-vinyl benzimide, 4,4,9-trimethyl-4-azonia-7-oxo-8-oxa-dec-9-ene-1-sulphonate, N,N-dimethyl-N-(beta-methacryloxyethyl)ammonium propionate betaine, trimethylamine methacrylimide, 1,1-dimethyl-1(2,3-dihydroxypropyl)amine methacrylimide, any zwitterionic monomer, and the like.

When used in the reaction mixture to produce the microsphere adhesive, up to 5 wt %, based on the fusel oil (meth)acrylate content, of an amino functional comonomer can be used. The amino functional comonomer can have a nucleus or portion of the nucleus. Nonlimiting examples of amino functional comonomer include N,N-dimethyl-aminoethyl(methyl)acrylate, N,N-dimethylaminopropyl(meth)acrylate, t-butylaminoethyl(methyl)acrylate and N,N-diethylamino(meth)acrylate.

When used in the reaction mixture to produce the microsphere adhesive, depending upon the desired properties, up to 5 wt %, in some embodiments up to 8 wt %, and in some other embodiments up to 10 wt %, based on the fusel oil (meth)acrylate content, of an amido functional comonomer can be used. The amido functional comonomer can have a nucleus or a portion of a nucleus. Nonlimiting examples of amido functional comonomer include N-vinyl pyrrolidone, N-vinyl caprolactom, acrylamide, N,N-dimethyl acrylamide, and combinations thereof.

When used in the reaction mixture to produce the microsphere adhesive, up to 5 wt %, in some embodiment up to 8 wt %, and in some other embodiment up to 10 wt %, based on the fusel oil (meth)acrylate content, of one of the following polymerizable comonomer can be used: 2-hydroxyethyl(meth)acrylate, glycerol mono(meth)acrylate and 4-hydroxybutyl(meth)acrylate, (meth)acrylate terminated poly(ethylene oxide); (meth)acrylate terminated poly(ethylene glycol); methoxy poly(ethylene oxide)methacrylate; butoxy poly(ethylene oxide)methacrylate; and combinations thereof.

Typically, when the polymerizable comonomer is present in the reaction mixture, the relative amounts by weight of the fusel oil (meth)acrylate monomer and the polymerizable comonomer is in the range of about 99.5/0.5 to 25/75, and preferably is in the range of 98/2 to 50/50.

Solute Polymer

Another component that may be added to the reaction product to prepare the microsphere adhesive is a solute polymer as described in detail in U.S. Pat. No. 5,824,748 (Kesti et al.).

A solute polymer, which is essentially water insoluble may be comprised of any monomer or mixture of monomers that upon polymerization provides a polymer that can be dissolved into the fusel oil (meth)acrylate monomer or a mixture of the fusel oil (meth)acrylate monomer and the polymerizable comonomers described above. Typically, solute polymers have a number average molecular weight of at least 2000.

The solute component is comprised of various classes of polymers. For example, the solute polymer may be branched or may be modified. The solute polymer may be prepared using water reactive or water soluble monomers, monomers that are not free-radically polymerizable, and combinations thereof. Furthermore, the solute polymers may be prepared according to any polymerization method that may be known to those skilled in the art and can be generally found in various references such as “Principles of Polymerization” Odian, 3rd ed., Wiley Interscience.

Nonlimiting examples of useful solute polymers include poly(acrylates), poly(methacrylates), poly(styrene), elastomers such as rubbers (natural and or synthetic) or styrene-butadiene block copolymers, polyurethanes, polyureas, polyesters, crystalline and non-crystalline polymers such as crystalline and non-crystalline poly-alpha-olefins, crystalline poly(methacrylate) and crystalline poly(acrylate), and mixtures thereof.

Advantageously, this disclosure provides a composite microsphere PSA that can incorporate moieties that normally react in the water phase when used in monomeric forms prior to suspension polymerization of such monomers. Nonlimiting examples of solute polymers comprised of such water reactive moieties include, but are not limited to polymers containing maleic anhydride, itaconic anhydride, 2-vinyl-4,4-dimethyl-2-oxazoline-5-one (VDM), and 2-(isocyanato)ethyl methacrylate.

Furthermore, highly water soluble moieties, such as (meth)acrylic acid, N-vinyl pyrrolidone, (meth)acrylamide, poly(ethylene)oxide macromonomer, 1,1-dimethyl-1(2-hydroxylpropyl)amine methacrylimide, 1,1,1-trimethylamine methacrylimide, 1,1-dimethyl-1(2,3-dihydroxypropyl)amine methacrylimide, and other water soluble moieties, such as, N,N-dimethyl-N-(beta-methacryloxyethyl)ammonium propionate betaine, 4,4,9-trimethyl-4-azonia-7-oxo-8-oxa-dec-9-ene-1 sulfonate, sodium(meth)acrylate, ammonium acrylate, and maleic anhydride, for example can also be incorporated into the solute polymer used in the preparation of the composite pressure sensitive adhesive microspheres, provided that the solute polymer is essentially water insoluble.

Suspension Polymerization Process

The microsphere adhesives of the present disclosure are prepared by suspension polymerization. Suspension polymerization is a procedure wherein a monomer is dispersed in a medium (usually aqueous) in which it is insoluble. The polymerization is allowed to proceed within the individual monomer droplets. Monomer soluble free-radical initiators are preferably used. The kinetics and the mechanism are those for the corresponding bulk polymerization under similar conditions of temperature and initiator concentration.

To initiate the polymerization reaction, a sufficient number of free radicals are present. This may be achieved through several means, such as heat or radiation free-radical initiation. For example, heat or radiation can be applied to initiate the polymerization of the monomers, which results in an exothermic reaction. However, it is preferred to apply heat until thermal decomposition of the initiators generates a sufficient number of free radicals to begin the reaction. The temperature at which this occurs varies greatly depending upon the initiator used.

In addition, deoxygenation of the polymerization reaction mixture is often desirable. Oxygen dissolved in the reaction mixture can inhibit polymerization and it is desirable to expel this dissolved oxygen. Although, an inert gas bubbled into the reaction vessel or through the reaction mixture is an effective means of deoxygenation, other techniques for de-oxgenation that are compatible with suspension polymerization can be used. Typically, nitrogen is used to deoxygenate, although any of the Group VIIIA (CAS version) inert gases are also suitable.

While specific time and stirring speed parameters are dependent upon monomers, and initiators, it may be desirable to pre-disperse the reaction mixture until the reaction mixture reaches a state where the average monomer droplet size is between about 1 and 300 micrometer, and preferably between 20 and 75 micrometer. The average particle size tends to decrease with increased and prolonged agitation of the reaction mixture.

Preferably, stirring and nitrogen purge are maintained throughout the reaction period. Initiation begins by heating the reaction mixture. Following polymerization, the reaction mixture is cooled.

In a one-step process both the fusel oil (meth)acrylate monomer and any optional other polymerizable comonomer are present together in the suspension at the initiation of polymerization. The other components, such as the initiator, stabilizers, surfactants (if used) and modifiers are present in the reaction mixture.

Following polymerization, a stable aqueous suspension of microspheres at room temperature is obtained. The suspension may have non-volatile solids contents of from about 10 to about 70 percent by weight. The aqueous suspension of microspheres may be used immediately following polymerization because the suspension of microspheres is particularly stable to agglomeration or coagulation. The microspheres can be coated from an aqueous solution by a conventional coating techniques such as slot die coating to provide an adhesive coating.

The microspheres can be compounded with various rheology modifiers and/or latex adhesives or “binders”. Typically, the adhesive coating which, when dried, exhibits a dry coating weight in the range of 0.2 to 2 grams per square foot to provide an adhesive-coated sheet material in which the adhesive coating comprises polymeric microspheres, polymeric stabilizer, surfactant, and optionally rheology modifiers, and/or latex binder.

Properties of the microsphere PSAs of the present disclosure can be altered by the addition of a tackifying resin(s) and/or plasticizer(s) after the polymerization. Preferred tackifiers and/or plasticizers for use herein include hydrogenated rosin esters commercially available from such companies as Hercules, Inc. under the trade names of FORAL®, REGALREZ® and PENTALYN®. Tackifying resins also include those based on t-butyl styrene. Useful plasticizers include but are not limited to dioctyl phthalate, 2-ethylhexyl phosphate, tricresyl phosphate and the like. If such tackifiers and/or plasticizers are used, the amounts used in the adhesive mixture are amounts effective for the known uses of such additives.

Optionally, modifiers such as, rheology modifiers, colorants, fillers, stabilizers, pressure-sensitive latex binders and various other polymeric additives can be utilized. If such modifiers are used, the amounts used in the adhesive mixture are amounts effective for the known uses of such modifiers.

Substrates

Suitable backing or substrate materials for use in the present invention include, but are not limited to, paper, plastic films, cellulose acetate, ethyl cellulose, woven or nonwoven fabric comprised of synthetic or natural materials, metal, metallized polymeric film, ceramic sheet material and the like. Generally the backing or substrate material is 10 to 155 micrometer in thickness, although thicker and thinner backing or substrate materials are not precluded. Typically the microsphere PSA composition will be applied or coated to at least a portion of a first side of the substrate. In some embodiments, a release coating is applied to a second side of the substrate generally in an area opposing that of the microsphere PSA.

Applications

Particularly useful articles prepared using the microsphere adhesives of the present invention include repositionable adhesive products such as repositionable note and paper products, repositionable tape and tape flags, easel sheets, repositionable glue stick and the like, but may also include other non-repositionable industrial commercial, and medical adhesive products.

### EXAMPLES

The invention will be further explained with the following illustrative inventions.

### Test Methods

The following test methods were used to evaluate the performance of the microsphere PSA of Example 1, 2 and Comparative Example C1.

Adhesion to Bond Paper

Peel adhesion is the force required to remove a coated sheet from a bond paper substrate at a specific angle and rate of removal. In the examples this force is expressed in grams per one inch width of coated sheet. The procedure followed is:

A strip, one inch (2.54 cm) wide, of coated sheet is applied to the horizontal surface of 20 pound (9.1 kg) bond paper. A 4.5 pound (2.0 kg) hard rubber roller is used to firmly apply the strip to the bond paper. The free end of the coated sheet is attached to the adhesion tester load cell such that the angle of removal will be 90°. The test plate is then clamped in the jaws of the tensile testing machine which is capable of moving the plate away from the load cell at a constant rate of 12 inches (30.5 cm) per minute. A load cell reading in grams per inch of coated sheet is recorded. The test was repeated and the data is reported as the average of the number of 3 trials.

Aged Adhesion to Bond Paper:

A one inch (2.5 cm) wide strip of coated sheet is applied to the horizontal surface of 20 pound bond paper. A 4.5 pound (2 kg) hard rubber roller is used to firmly apply the strip to the bond paper. The laminates were aged at 70° F. (21° C.) and 80% relative humidity for 72 hours. After aging, peel adhesion of the samples was performed according to the test method of Adhesion to Bond Paper described above.

Tack

A TA-XT2i Texture Analyser made by Texture Technologies Corp. is used for the tack measurement. The specimen is held adhesive side up by a brass test fixture. A 7 mm stainless steel probe is brought into contact with the specimen until a specified force is reached, usually 100 g. After one second contact time, the probe is raised at speed of 0.5 mm/sec and the force of adhesion is measured as a function of the distance of the probe from the specimen. The tack is the peak removal force.

Static Angle Testing (SAT)

The SAT measures the ability of the sample to remain adhered on a standard test panel while being subjected to removal pressure at a specified peel angle under a constant load. The static angle test is one quantitative procedure for measuring detachment resistance of the sample.

In performing static angle test, six samples can be prepared using the following exemplary process. Each sample includes an adhesive stripe that is 18 mm wide by 33 mm long.

The test panel is a steel panel with a painted surface. Each sample is applied to the painted steel panel with the long dimension of the adhesive stripe horizontally oriented and located at the top of the photo media sample. Then, the sample is pressure adhered to the painted steel surface by two passes of an application roller with an application pressure of 1.5 pounds per square inch (77.6 mm of mercury).

The mounted sample is placed in a holder frame that is vertically oriented approximately perpendicular to a ground surface. The painted steel panel is held at a 300 downward angle relative to the vertically oriented frame. A 100 gram load is applied to the lower end of the coated sheet sample, proximate to the lower end of the holder frame. A timer is started upon application of the 100 gram load to measure how long the sample remains attached to the painted steel surface before the coated sheet sample detaches from the steel panel. The SAT usually runs to failure, i.e., until the sample actually detaches from the steel panel. The time to detachment is usually measured in seconds as the average of six results.

TABLE 1
Polymerization formulations of Examples 1, 2 and
Comparative Example C1

| Component | | Ex. 1 | Ex. 2 | Ex. C1 |
|---|---|---|---|---|
| function | Component | (grams) | (grams) | (grams) |
| main | fusel oil acrylate derived from | 314 | 0 | 0 |
| monomer | non-petroleum resource | | | |
| main | purified fusel oil derived from | 0 | 314 | 0 |
| monomer | non-petroleum resource | | | |
| main | 2-ethyl hexyl acrylate derived | 0 | 0 | 314 |
| monomer | from a petroleum resource | | | |
| comonomer | 2-hydroxyethylmethacrylate | 3.20 | 3.20 | 3.20 |
| co-monomer | N-vinylpyrrolidone | 0.32 | 0.32 | 0.32 |
| co-monomer | polyethylene oxide | 1.63 | 1.63 | 1.63 |
| | methacrylate (N K Ester | | | |
| | M90G) | | | |
| chain | t-dodecyl mercaptan | 0.10 | 0.10 | 0.10 |
| transfer | | | | |
| agent | | | | |
| initiator | PERKODOX ® 16 | 0.32 | 0.32 | 0.32 |
| initiator | LUPEROX ® A75 | 0.63 | 0.63 | 0.63 |
| reaction | deionized water | 258 | 258 | 258 |
| medium | | | | |
| surfactant | ammonium lauryl sulfate | 2.36 | 2.36 | 2.36 |
| | (STEPANOL ® AMV) | | | |
| surfactant | polyoxyethylene alkylphenyl | 2.64 | 2.64 | 2.64 |
| | ether ammonium sulfate | | | |
| | (HITENOL ® BC-1025) | | | |
| polymeric | Polyacrylamide | 0.18 | 0.18 | 0.18 |
| stabilizer | (CYANAMER ® N-300) | | | |
| ionic | Na styrene sulfonate | 1.29 | 1.29 | 1.29 |
| monomer | | | | |
| pH buffer | Na bicarbonate | 0.13 | 0.13 | 0.13 |

N K Ester M90G: polyethylene oxide methacrylate from Shin Nakamura Chemical Company, Ltd. and Towa. Inc., both from Japan
PERKODOX® 16: di(4-tert-butylcyclohexyl)peroxydicarbonate from Akzo Nobel, Amsterdam, the Netherlands
LUPEROX® A75: benzoyl peroxide from Arkema, Philadephia, Pa.
STEPANOL® AMV: ammonium lauryl sulfate from Stepan Co., Northfield, Ill.
HITENOL® BC-1025: polyoxyethylene alkylphenyl ether ammonium sulfate from Montello Inc., Tulsa, Okla.
CYANAMER® N-300: polyacrylamide from Cytek

### Example 1

### Microsphere Adhesive Polymerization Process

The fusel oil acrylate microsphere adhesive was prepared in water by a suspension polymerization process. To prepare the fusel oil acrylate microsphere adhesives of Example 1, the components indicated in Table 1 were charged into a 4 neck flask equipped with a reflux condenser, thermometer, stirrer, and a nitrogen gas inlet. The mixture was then mixed at 350 revolutions per minute for 30 minutes to achieve a desired monomer droplet size of around 50 micrometer. Once the monomer droplet size is in the specification as determined by an optical microscopy, the suspension was heated to an initiation temperature of 45° C. under a nitrogen atmosphere to initiate the polymerization. The reaction was allowed to exotherm. After polymerization, the batch was cooled to room temperature and filtered through a cheese cloth to remove coagulum. The particle size of the microsphere was 46 micrometer, as measured by a particle size analyzer, Horiba LA910. The percent extractable, i.e., the percent of soluble polymer in the microsphere adhesive was 52%.

### Example 2

The purified fusel oil acrylate microsphere was prepared as in Example 1, except that the components indicated in Table 1 were used. The particle size of the microsphere was 46 micrometer, as measured by a particle size analyzer, Horiba LA910. The percent extractable of this example was 35%.

### Comparative Example C1

The microsphere adhesive of this example was prepared in water by suspension polymerization similar to that of Example 1 by charging the components listed in Table 1 were charged into a 4 neck flask. The 2-ethylhexylacrylate used was commercially available from Aldrich Chemicals and was derived from a petroleum resource. Particle size of the microsphere was 47 micrometer, as measured by a particle size analyzer, Horiba LA910. The percent extractable of this example was 42%.

### Microsphere PSA Composition

The microsphere adhesives of Examples 1, 2 and Comparative Example C1 were then compounded with a latex binder, CARBOTAC® 26222, and a thickener, KELZAN® S and ACRYSOL® TT935, according Table 2. Viscosity of the microsphere PSA compositions was adjusted by the thickeners to be around 950 cps measured at 30 rpm by a Brookfield Viscometer. The compounded microsphere PSA compositions were coated on paper at a coat weight of 0.35 grams per square foot for evaluation.

TABLE 2
Compounding formulations of Examples 1, 2 and
Comparative Example C1

| Ingredients | Ex. 1 | Ex. 2 | Ex. C1 |
|---|---|---|---|
| Fusel oil acrylate microsphere PSA | 400 | 0 | 0 |
| (Example 1) | | | |
| Purified fusel oil acrylate microsphere PSA | 0 | 400 | 0 |
| (Example 2) | | | |
| Comparative Example 1 | 0 | 0 | 400 |
| CARBOTAC ® 26222 (Binder) | 16 | 16 | 16 |
| KELZAN ® S (Thickener) | 0.43 | 0.43 | 0.43 |
| deionized water | 13.75 | 13.75 | 13.75 |
| ACRYSOL ® TT935 (Thickener) | 3.46 | 3.46 | 2.65 |
| Sodium Hydroxide (10% solution) | 3.1 | 3.1 | 1.63 |
| MSA viscosity (cps at 30 rpm) | 930 | 930 | 960 |

TABLE 3
Adhesive Performance of Examples 1, 2, and C1 at an adhesive
dry coating weight of 0.350 gram per square foot

| Tests | Ex. 1 | Ex. 2 | Ex. C1 |
|---|---|---|---|
| Initial adhesion to paper (gram/in) | 58 | 55 | 53 |
| Aged adhesion to paper (grams/in) | 84 | 66 | 89 |
| % Adhesion Built up on paper* | 45% | 20% | 68% |
| Tack/texture analyzer (gram) | 25 | 22 | 14 |
| Static Angle Testing (seconds) | 477 | 373 | 47 |
| Biobased Content in Microsphere PSA | 61% | 61% | 0% |
| determined by ASTM D6866-06a | | | |

*% Adhesion built up on paper is defined as % of (Aged adhesion to paper - Initial adhesion to paper)/Initial adhesion to paper. It is considered the adhesive has no adhesion build, i.e. 0%, if the calculated number is 0 or negative. The adhesive of Comparative Example C1 had higher adhesion build over time. In many applications, the increase in adhesion build is undesirable because more peel force is required to remove the sample from the surface to which it is attached.

To determine if a microsphere adhesive contains biobased material so that it is considered non-petroleum adhesive of the present invention, ASTM D 6866-06a, Standard Test Methods for Determining the Biobased Content of Natural Range Materials Using Radiocarbon and Isotope Ratio Mass Spectrometry Analysis, was used to determine biobased content of the Examples 1, 2, and C1. The renewable microsphere adhesives of Examples 1, 2, and C1, prepared from petroleum based 2EHA monomer, were submitted to University of Georgia, Center for Applied Isotope Studies for determination of biobased content by the ASTM D 6866-06a. The test results show the petroleum based adhesive, Comparative Example C1, contains 0% biobased material, and the renewable microsphere adhesives of Examples E1 and E2 contain 61% biobased material.

As the data in Table 3 indicates, Examples 1 and 2 perform as well as, and in some cases, better than Comparative Example C1. For example, the SAT data of Examples 1 and 2 far outperforms that of Comparative Example C1, meaning that the microsphere PSA of Examples 1 and 2 have much longer hanging time when applied to a vertical surface such as a wall.

Several patent applications and patents are cited herein; each is incorporated by reference herein in its entirety.

Various modifications and alterations of this invention will become apparent to those skilled in the art without departing from the scope and spirit of this invention.

What is claimed is:

1. An adhesive comprising a reaction product of:
(a) a polymerizable composition comprising at least one polymerizable acrylate derived from one or more alcohols selected from the group consisting of C₄ alcohols, C₅ alcohols, and combinations thereof wherein at least one of the alcohols is derived from a non-petroleum resource;
(b) at least one initiator; and
(c) at least one stabilizer,
wherein the reaction occurs in water to yield a microsphere adhesive.

2. The adhesive of claim 1 wherein said polymerizable composition comprises 60 to 100 parts by weight of amyl acrylates, 0 to 20 parts by weight of isobutyl acrylate, and 0 to 10 parts by weight of propyl acrylate per 100 parts by weight of said polymerizable composition.

3. The adhesive of claim 1 wherein said polymerizable composition comprises polymerizable acrylate derived from one or more alcohols selected from the group consisting of amyl alcohol, butanol, or combinations thereof.

4. The adhesive of claim 3 wherein said alcohols are derived from fusel oil.

5. The adhesive of claim 1 wherein said adhesive has a biobased carbon content of at least about 30%.

6. The adhesive of claim 1 wherein said adhesive has a biobased carbon content of at least about 40%.

7. The adhesive of claim 1 wherein said adhesive has a biobased carbon content of at least about 50%.

8. The adhesive of claim 1 wherein said adhesive has a biobased carbon content of at least about 60%.

9. The adhesive of claim 1 wherein the reaction product further comprises a surfactant.

10. The adhesive of claim 1 comprising from about 92.0 to 99.9 wt % of component (a), from about 0.01 to 4.0 wt % component (b); and from about 0.01 to 4 wt % of component (c), wherein the wt % of each component is based on the total weight of all the components.

11. A pressure sensitive adhesive composition comprising:
(a) microsphere adhesive comprising a reaction product of (i) at least one polymerizable acrylate derived from one or more alcohols selected from the group consisting of C₄ alcohols, C₅ alcohols, and combinations thereof wherein at least one of the alcohols is derived from a non-petroleum resource; (ii) at least one initiator; and (iii) at least one stabilizer, wherein the reaction occurs in water;
(b) at least one pressure sensitive adhesive binder; and
(c) at least one thickener.

12. The composition of claim 11 comprising from about 90 to 98 wt % component (a), from about 1 to 10 wt % component (b), and from about 0.1 to 3.0 wt % component (c).

13. The composition of claim 12 disposed on at least a portion of a first surface of a backing selected from the group consisting of paper, polymeric film, woven fabric, non-woven fabric of synthetic or natural materials, metal, metallized polymeric film, and ceramic sheet.

14. An adhesive comprising a reaction product of:
(a) from about 92.0 to 99.9 wt % of at least one polymerizable acrylate derived from esterification of (i) one or more alcohols selected from the group consisting of C₄ alcohols, C₅ alcohols, and combinations thereof and (ii) (meth)acrylic acid, wherein at least one of said alcohol and said (meth)acrylic acid is derived from a non-petroleum resource;
(b) from about 0.01 to 4 wt % of at least one stabilizer; and
(c) from about 0.01 to 4.0 wt % of at least one initiator;
wherein the wt % of each component is based on the total of components (a) to (c) and wherein the reaction occurs in water to yield a microsphere adhesive.

15. The adhesive of claim 14 further comprising a polymerizable comonomer selected from the group consisting of:
(1) up to about 75 wt % of at least one alkyl(meth)acrylate comonomer having from about 1 to 14 carbon atoms;
(2) up to about 30 wt % of at least one solute polymer;
(3) less than about 5 wt % at least one polar comonomer;
(4) up to about 10 wt % of at least one amido comonomer;
(5) up to about 10 wt % of at least one polyethylene oxide methacrylate comonomer,
(6) up to about 5 wt of at least one ionic comonomer,
(7) up to about 1 wt % of at least one crosslinker; and
(8) combinations thereof,
wherein the wt % is based on the polymerizable monomer content.

16. The adhesive of claim 14 further comprising at least one component selected from the group consisting of up to about 0.2 wt %, based on the polymerizable monomer content, of chain transfer agent and crosslinker.

17. A microsphere adhesive composition comprising:
(a) from about 90 to 98 wt % of the microsphere adhesive of claim 14;
(b) from about 1 to 10 wt % of at least one binder; and
(c) from about 0.1 to 3.0 wt % of at least one thickener.

18. An adhesive article comprising the microsphere adhesive of claim 14 disposed on at least a portion of a first surface of a backing selected from the group consisting of paper, polymeric film, woven fabric, non-woven fabric of synthetic or natural materials, metal, metallized polymeric film, and ceramic sheet.

19. The article of claim 18 further comprising a release coating disposed on at least a portion of a second surface of the backing such that the release coating lies substantially opposing the adhesive composition.

20. An adhesive consisting of a reaction product of:
(a) from about 87 to 99.9 wt % of at least one polymerizable acrylate derived from esterification reaction of (i) one or more alcohols selected from the group consisting of C₄ alcohols, C₅ alcohols, and combinations thereof and (ii) (meth)acrylic acid, wherein at least one of said alcohol and said (meth)acrylic acid is derived from a non-petroleum resource;
(b) from about 0.01 to 5 wt % of at least one surfactant;
(c) from about 0.01 to 4 wt % of at least one polymeric stabilizer;
(d) from about 0.01 to 4.0 wt % of at least one initiator;
wherein the wt % of each component is based on the total of components (a) to (d);
(e) up to about 75 wt %, based on component (a), of at least one alkyl(meth)acrylate comonomer having from about 1 to 14 carbon atoms;
(f) less than about 5 wt %, based on component (a), of at least one polar comonomer;
(g) up to about 10 wt %, based on component (a), of at least one amido comonomer;
(h) up to about 10 wt %, based on component (a), of at least one polyethylene oxide(meth)acrylate;
(i) up to about 30 wt %, based on component (a), of at least one solute polymer;
(j) up to about 0.2 wt %, based on component (a), of at least one chain transfer agent; (k) up to about 1%, based on component (a), of at least one crosslinker;
(k) up to about 5 wt %, based on component (a), of at least one amino comonomer;
(l) up to about 5 wt %, based on component (a), of at least one ionic monomer;
(m) up to about 20 wt %, based on component (a), of at least one vinyl or vinylester comonomer,
wherein the reaction occurs in water to yield a microsphere adhesive.

21. The adhesive of claim 20 wherein the alkyl(meth)acrylate comonomer is selected from the group consisting of isooctyl(meth)acrylate, 2-octyl(meth)acrylate, isononyl(meth)acrylate, isoamyl(meth)acrylate, isodecyl(meth)acrylate, 2-ethylhexyl(meth)acrylate, n-butyl(meth)acrylate, sec-butyl(meth)acrylate, propyl(meth)acrylate, ethyl(meth)acrylate, methyl(meth)acrylate, isobornyl(meth)acrylate, 4-methyl-2-pentyl(meth)acrylate, 2-methylbutyl(meth)acrylate, t-butyl(meth)acrylate, and combinations thereof.

22. The adhesive of claim 20 wherein the polar comonomer is selected from the group consisting of (meth)acrylic acid, 2-hydroxyethyl(meth)acrylate, and combinations thereof.

23. The adhesive of claim 20 wherein the amido comonomer is selected from the group consisting of N-vinyl pyrrolidone, N-vinyl caprolactom, (meth)acrylamide, N, N-dimethyl acrylamide, and combinations thereof.

24. A microsphere adhesive composition comprising:
(a) from about 90 to 98 wt % of the microsphere adhesive of claim 23;
(b) from about 1 to 10 wt % of at least one binder; and
(c) from about 0.1 to 3.0 wt % of at least one thickener.

25. An adhesive article comprising the microsphere adhesive of claim 24 disposed on at least a portion of a first surface of a backing selected from the group consisting of paper, polymeric film, woven fabric, non-woven fabric of synthetic or natural materials, metal, metallized polymeric film, and ceramic sheet.

26. The article of claim 25 further comprising a release coating disposed on at least a portion of a second surface of the backing such that the release coating lies substantially opposing the adhesive composition.
